(19) United States
(12) Patent Application Publication
(10) Pub. No.: US 2017/0218316 A1
(43) Pub. Date: Aug. 3, 2017

(54) Novel System for Germinating and Malting Grain

(71) Applicant: Thomas K. Blake, Bozeman, MT (US)

(72) Inventor: Thomas K. Blake, Bozeman, MT (US)

(21) Appl. No.: 15/011,097

(22) Filed: Jan. 29, 2016

(51) Int. Cl. C12C 1/135

(52) U.S. Cl. CPC C12C 1/135

(57) ABSTRACT

The present invention relates to a novel grain germination and malting apparatus and uses thereof. The apparatus comprises a 4-tank malting and seed germination system in which each tank performs steeping, germination and kilning, as it is moved along a 2-track rail. At the first station grain is hydrated, a process typically requiring four cycles of steeping with aeration followed by air rest. Germination is continued in the second and third stations, with aeration by water-saturated air. Germination typically takes a minimum three days, but depending on genotype and species, may take as much as eight days. Kilning is performed at station four, using fan-driven, electrically-heated air to dry and cure the malt.

### RELATED APPLICATIONS

This application is claims priority to U.S. Provisional Patent Application Ser. No. 62/164,300, filed May 18, 2015 the contents of which are incorporated herein by reference in their entirety.

### FIELD OF THE INVENTION

Embodiments of the invention relate to an apparatus for malting and/or germinating grain and to methods of malting or germinating grain using the apparatus.

### BACKGROUND OF THE INVENTION

The traditional malting industry in the United States is dominated by industrial malting companies that own and operate one or more malthouses. Each of these malthouses produces more than one hundred thousand tons of malt per year. This malt is produced from a small number of barley varieties that have been selected to meet the specifications of the large brewing companies that retain market domination.

Craft brewers, distillers and artisanal bakers provide products with a broad array of flavors and textures that often differ from those provided by larger companies. These demand a broader array of malted and germinated grains processed using methods inappropriate for large malthouses.

The craft malting industry in the United States consists of a small number of maltsters and their malting systems that produce malt or germinated grains for nearby brewers, distillers or artisanal bakers. These malting systems are predominately made on-site. No moderately-priced malting system appropriate for maltsters, craft brewers, distillers or artisanal bakers is currently available.

Thus, there exists a need in the art for a flexible, easy-to-use malting and grain germination system that permits users to produce small batches of unique malts and germinated grains. Fortunately, as will be clear from the following disclosure, the present invention provides for this and other needs.

### SUMMARY OF THE INVENTION

In one embodiment, the disclosure provides an apparatus for germinating and malting grain, the apparatus comprising: (i) four tanks suitable for steeping, germinating and kilning grain, wherein each tank comprises a tank bottom and a tank top, wherein the tank bottom has a closed side and an open side, and wherein a male fitting is attached to an opening in the closed side thereby providing a channel through which substances may enter and/or exit the tank through the tank bottom, and wherein the tank top has a closed side and an open side, wherein a male fitting is attached to an opening in the closed side thereby providing a channel through which substances may enter and/or exit the tank through the tank top, and wherein the tank top and the tank bottom are oriented such that the open side of the tank bottom is up and the open side of the tank top is down, and wherein the tank bottom has an interior and an exterior and the tank bottom interior has a floor, wherein the floor has upon it and aeration ring, and wherein a support structure is placed on the tank bottom above the aeration ring and a screen is on top of the support structure; (ii) four tank carts, wherein each tank cart comprises: a square frame having a top side and a bottom side, wherein the top side accommodates a tank, and wherein a wheel is affixed to each corner of the bottom side; (iii) a 2-track rail which comprises segments, each segment comprising: (a) a first C-channel rail and a second C-channel rail wherein each C-channel rail has a top side and a bottom side and has a left end and a right end and wherein the first C-channel rail and the second C-channel rail are oriented horizontally with respect to the ground and parallel to each other wherein the top sides of the C-channel rails are oriented up and the bottom sides are oriented down; (b) four rail legs wherein each rail leg has a top end and a bottom end, wherein a first rail leg is attached at the top end to the bottom side of the left end of the first C-channel rail, a second rail leg is attached at the top end to the bottom side of the right end of the first C-channel rail, a third rail leg is attached at the top end to the bottom side of the right end of the second C-channel rail, and a fourth rail leg is attached at the top end to the bottom side of the right end of the second C-channel rail (c) a first cross brace and a second cross brace wherein each cross brace has a first end and a second end, wherein the first cross brace is attached by the first end to the first rail leg and is attached by the second end to the third rail leg, and wherein the second cross brace is attached by the first end to the second rail leg and is attached by the second end to the fourth rail leg; (d) a first X-brace and a second X-brace wherein each X-brace has a first end and a second end, wherein the first X-brace is attached by the first end to the first rail leg and the first end of the first cross brace and is attached by the second end to the fourth rail leg and the second end of the second cross brace, and wherein the second X-brace is attached by the first end to the second rail leg and the first end of the second cross brace and is attached by the second end to the third rail leg and the second end of the first cross brace, wherein the 2-track rail provides a path along which is a steeping station, a first germination station, a second germination station, and a kilning station; wherein the steeping station comprises plumbing to provide a water supply line, a water drain line and an air supply line, wherein the first germination station comprises plumbing to provide an air supply line a water supply line and a water drain line, wherein the second germination station is comprises plumbing to provide an air supply line a water supply line and a water drain line, wherein the kilning station is comprises a kiln plenum with a heating element and an in-line fan capable of providing 600 cubic feet of air per minute.

In one exemplary embodiment, the apparatus comprises three segments of 2-track rail.

In one exemplary embodiment, the tanks are 36 inches high, have an internal diameter of 26 inches and external diameter of 28 inches and wherein the tanks are made of 14 gauge stainless steel. In another exemplary embodiment, the apparatus is used to produce 0.3 tons of malt per week. In another exemplary embodiment, each C-channel rail is 60 inches long, each rail leg is 23 inches long, each cross brace is 32.5 inches long and each X-brace is 67.4 inches long.

In one exemplary embodiment, the tanks are 36 inches high, have an internal diameter of 9 inches. In one exemplary embodiment, apparatus is used to produce 20 pounds of malt per week.

In one exemplary embodiment, the tanks are 36 inches high, have an internal diameter of 37 inches. In one exemplary embodiment, the apparatus is used to produce one ton of malt per week.

In one embodiment, the disclosure provides method for steeping, germinating, drying and curing grain using an apparatus for germinating and malting grain, the method comprising: (i) placing a first tank cart on the 2-track rail at the steeping station, ii) placing a first tank suitable for steeping, germinating and kilning grain on the first tank cart, (iii) adding grain to a first tank suitable for steeping, germinating and kilning grain (iv) steeping the grain in the first tank suitable for steeping, germinating and kilning grain until steeping is complete; (v) moving the first tank cart along the 2-track rail to the first germination station; (vi) allowing the grain in the first tank suitable for steeping, germinating and kilning grain to germinate until germination is half complete; (vii) placing a second tank cart on the 2-track rail at the steeping station; (viii) placing the second tank suitable for steeping, germinating and kilning grain on the second tank cart, (ix) adding grain to a second tank suitable for steeping, germinating and kilning grain (x) steeping the grain in the second tank suitable for steeping, germinating and kilning grain until steeping is complete; (xi) moving the first tank cart along the 2-track rail to the second germination station and moving the second tank cart along the 2-track rail to the first germination station; (xii) allowing the grain in the first tank suitable for steeping, germinating and kilning grain to germinate until germination is complete and allowing the grain in the second tank suitable for steeping, germinating and kilning grain to germinate until germination is half complete; (xiii) placing a third tank cart on the 2-track rail at the steeping station; (xiv) placing the third tank suitable for steeping, germinating and kilning grain on the third tank cart, (xv) adding grain to a third tank suitable for steeping, germinating and kilning grain; (xvi) steeping the grain in the third tank suitable for steeping, germinating and kilning grain until steeping is complete; (xvii) moving the first tank cart along the 2-track rail to the kilning station, moving the second tank cart along the 2-track rail to the second germination station and moving the third tank cart along the 2-track rail to the first germination station; (xviii) allowing the grain in the first tank suitable for steeping, germinating and kilning grain to kiln until kilning is complete, allowing the grain in the second tank suitable for steeping, germinating and kilning grain to germinate until germination is complete; allowing the grain in the third tank suitable for steeping, germinating and kilning grain to germinate until germination is half complete; (xix) placing a fourth tank cart on the 2-track rail at the steeping station; (xx) placing the fourth tank suitable for steeping, germinating and kilning grain on the fourth tank cart, (xxi) adding grain to a fourth tank suitable for steeping, germinating and kilning grain; (xxii) steeping the grain in the fourth tank suitable for steeping, germinating and kilning grain until steeping is complete; (xxiii) removing the first tank suitable for steeping, germinating and kilning grain from the kiln when kilning is complete, therebysteeping, germinating, drying and curing grain using an apparatus for germinating and malting grain.

In an exemplary embodiment, prior to step vii water is added to the first tank suitable for steeping germinating and kilning grain and resteeping the grain therein.

In another exemplary embodiment, prior to step xiii adding water to the second tank suitable for steeping germinating and kilning grain and resteeping the grain therein.

In another exemplary embodiment, prior to step xix adding water to the first tank suitable for steeping germinating and kilning grain and resteeping the grain therein.

In one exemplary embodiment, the grain is barley (Hordeum vulgare), producing pale malt.

In another exemplary embodiment, in the grain is barley (Hordeum vulgare), used to produce partially stewed malt.

In another exemplary embodiment, the grain is hulless oats (Avena sativum), producing pale oat malt

Other features, objects and advantages of the invention will be apparent from the detailed description which follows.

### BRIEF DESCRIPTION OF THE DRAWINGS

FIG. 1. Provides an overview of a four-chambered apparatus for malting or germinating grain as disclosed herein. The apparatus comprises rails to support the carts and tanks, plumbing to allow steeping and draining at the steep station and resteeping at each of the two germination stations. Steep station and tank (1); first germination station and tank (2); second germination station and tank (3); kiln station and tank (4); kiln plenum (5) (note aperture for heating elements and in-line fan). Grain moves sequentially along a 2-track rail from the steep station (1) to the first germination station (2) then to the second germination station (3) and finally to the kiln station (4).

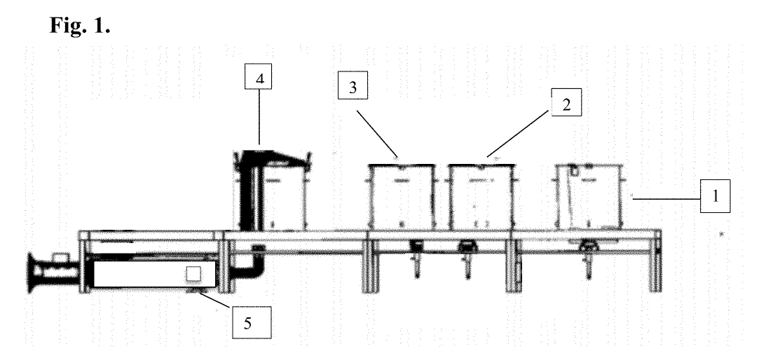

FIG. 2. Illustrates an exemplary embodiment of a Montana Mini-Malter, wherein chambers are cylinders made of 14-gauge stainless steel which have a 26-inch internal diameter, a 28 inch external diameter and which are 36 inches tall. In this embodiment, each chamber has a 4″ diameter male fitting welded into an opening in the base of the cylinder. Shown are the dimensions, in inches, of the chambers, including a linch rim at the chamber top. Drawing of the standard tank/chamber (6); Illustration of the 4″ diameter hole in the tank bottom (7); 4″ male camlock fitting to be welded to tank bottom (8); 4″ female camlock fitting compatible with male camlock fitting (9); 1″ diameter “t” fitting for water ingress and egress(10); 1″ solenoid valve for water egress (11); 1″ drain tube (12); 1″ solenoid valve for water ingress (13); 1″ water supply tube (14).

FIG. 3 Illustrates a tank handle with dimension for use in the Mini-Malter version of the apparatus for germinating and malting grain as disclosed herein. Each tank has eight handles welded to the tank exterior as disclosed herein below. The handles facilitate tank removal from the tank cart.

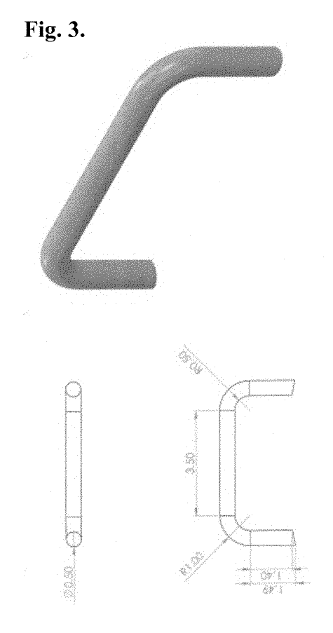

FIG. 4. Illustrates the 1-inch support structure (15) that rests atop the submersible stainless steel aeration ring (16) (see e.g., FIG. 5) on the bottom of each tank/chamber, providing a plenum and supporting a perforated stainless steel screen (17) (FIG. 6) that supports the grain. Measurements are shown in inches.

FIG. 5. Illustrates the submersible aeration ring (16) that sits on the bottom of each tank/chamber. In an exemplary embodiment the aeration ring has an outside diameter of 24″ and provides excellent aeration during steeping and germination. In an exemplary embodiment, the aeration ring is commercially available. At the center of the Aeration Ring is a threaded orifice that accommodates a standard 1″ diameter barbed tubing fitting. In exemplary embodiments Tygon® tubing (18) is fitted to the barb prior to introduction of the grain at the start of steeping. This tubing is then fitted to an air pump. During the two germination stages, the aeration ring is immersed in water, to provide hydrated air.

FIG. 6 is a schematic of the stainless steel screen (17) that supports the grain as described above in FIG. 4. Measurements are shown in inches.

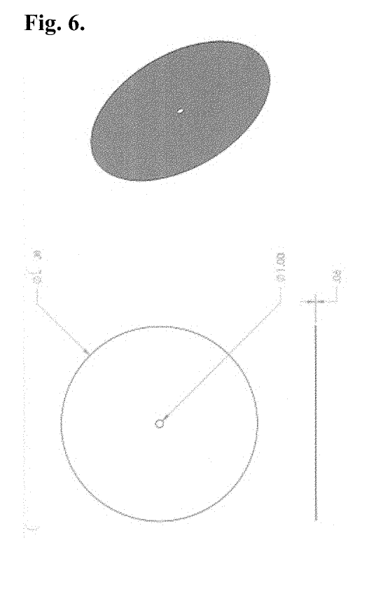

FIG. 7 illustrates the assembly of the tank components prior to addition of grain at the steep station (1). In the illustrated embodiment, the perforated stainless steel aeration ring (16) is placed on the bottom of the tank and Tygon® tubing (18) is attached to the barbed fitting at the center of the aeration ring. The tank plenum support (15) is placed atop the aeration ring (16), and the stainless steel grain support screen (17) is placed atop the tank plenum support (15). The Tygon® tubing (18) is drawn through the plenum support and grain support screen and is attached to the air pump.

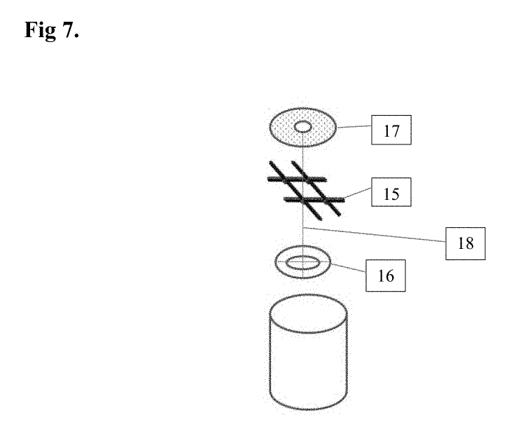

FIG. 8. Illustrates a segment of the rail system along which chambers move on the apparatus for germinating and malting grain. In an exemplary embodiment of a Montana Mini-Malter, the rail system is constructed from 2″ angle steel or 14 gauge stainless steel. C-channel rail (19); rail leg (20); rail x-brace (21); rail cross brace (22).

FIG. 9. Illustrates dimensional details of the C-channel rail (19) and the rail leg (20) for the Montana Mini-Malter embodiment of the apparatus for germinating and malting grain disclosed herein. Measurements are shown in inches. The length of each segment is 60 inches. The width of the C-channel rail is 4 inches and the depth of the channel is 1 inch. The length of the rail leg is 23 inches, the thickness of the angle steel is 0.19 inches and the depth of the angle in the angle steel is 2 inches.

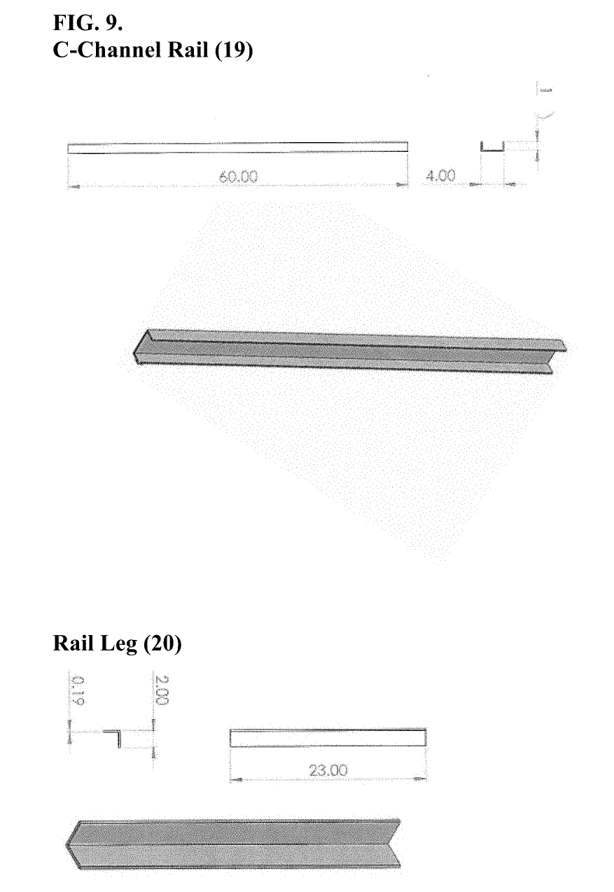

FIG. 10. Illustrates dimensional details of the X-brace (21) and the cross (or horizontal) brace (22) for the Montana Mini-Malter embodiment of the apparatus for germinating and malting grain disclosed herein. Measurements are shown in inches. The length of the X-brace is 67.43 inches; the width of the X-brace is 1.3 inches and the thickness of the steel is 0.14 inches. The length of the cross (or horizontal) brace is 32.50 inches; the width of the cross brace is 2 inches and the thickness of the steel is 0.19 inches.

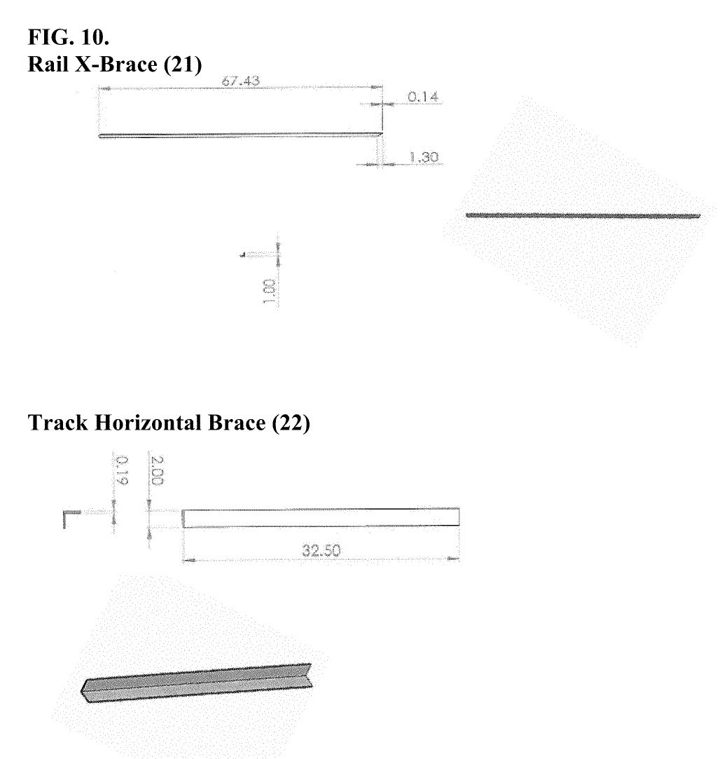

FIG. 11. Illustrates a tank/chamber cart. In exemplary embodiments, tank carts of equivalently chamber carts, are also constructed using 2″angle steel or 14 gauge stainless steel. 2″ cart side (23); cart corner piece (24); axle (25); wheel (26).

FIG. 12. Illustrates dimensional details of the tank/chamber cart side piece (27) and the tank cart corner piece (28) for the Montana Mini-Malter embodiment of the apparatus for germinating and malting grain disclosed herein. Measurements are shown in inches. The exterior line of the side piece is longer than the interior line. The length of the exterior line is 26.75 inches the interior line is 20.75 inches. The cart corner piece is tapered the long side is 11.50 inches, the short side is 10.37 inches. The small triangular piece is also tapered with the short side at 3.72 inches and the long side at 8.59 inches.

FIG. 13. Illustrates details and dimensions of the kiln plenum main chamber for the Montana Mini-Malter embodiment of the apparatus for germinating and malting grain disclosed herein. The figure shows a 6″×9″ heating element port. Measurements are shown in inches.

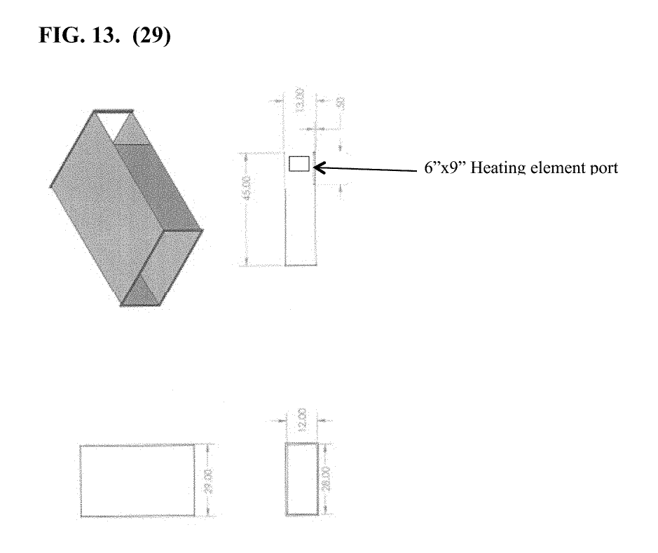

FIG. 14. Illustrates details of the kiln plenum front piece for the Montana Mini-Malter embodiment of the apparatus for germinating and malting grain disclosed herein. Measurements are shown in inches.

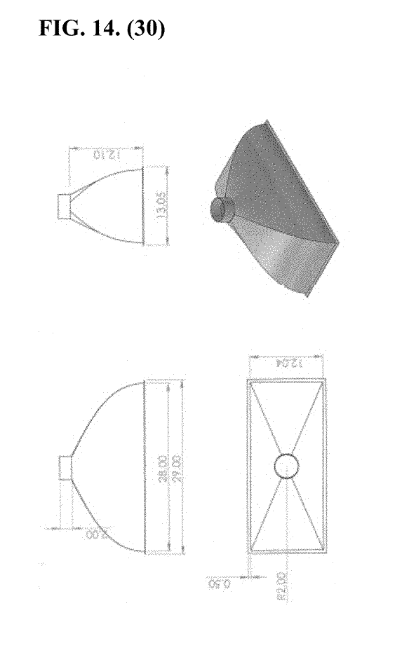

FIG. 15. Illustrates details of the kiln plenum rear piece for the Montana Mini-Malter embodiment of the apparatus for germinating and malting grain disclosed herein. Measurements are shown in inches.

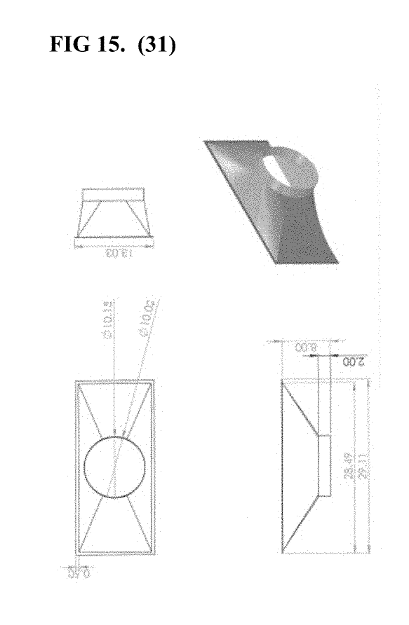

FIG. 16. Illustrates details of the 28″ diameter stainless steel tank top (32) with 4″ diameter hole (33) to which is welded a 4″ male camlock fitting, identical to that shown in FIG. 2.

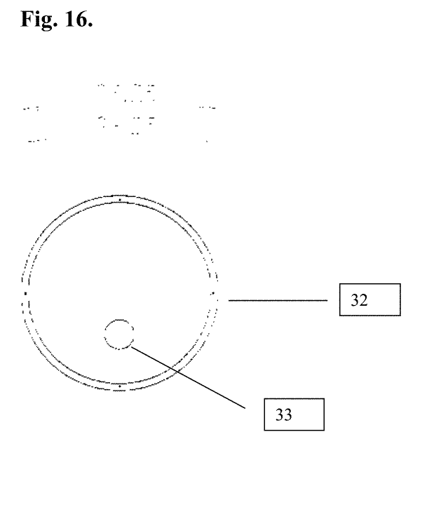

### DETAILED DESCRIPTION OF THE INVENTION

### Definitions

Unless defined otherwise, all technical and scientific terms used herein generally have the same meaning as commonly understood by one of ordinary skill in the art to which this invention belongs.

The term “grain” as used herein refers generally to the edible grain of members of grass or legume family plants. Exemplary grains include, but are not limited to e.g., barley, wheat, maize, rye, oats, corn, lentils and chickpeas and includes the seeds of any other plant that can be uniformly germinated e.g., flax, rice, sorghum, millet, triticale etc.

The expression “apparatus for germinating and malting grain” as used herein, refers to a four-tank (or equivalently four-chamber) malting and seed germination system in which each tank (or chamber) performs steeping, germination and kilning. In addition to the tanks, the “apparatus for germinating and malting grain” comprises a 2-track rail onto which tank/chamber carts are directly placed. The tanks/chambers are then placed on top of the tank carts so that the tanks/chambers can be moved from station to station along the rail. The “stations are equipped with appropriate connections and resources so that one or more of steeping, germination or kilning can be carried out at that “station”. For example, air and water supply lines are available at the “steep station”; water and air are available at the germination stations and fans are available at the kilning station. The “apparatus for germinating and malting grain” can be of any practical size. Thus, in some exemplary embodiments, an “apparatus for germinating and malting grain” has a capacity of between 10 lbs. per week and 80 pounds per week and is referred to herein as a “Montana Micromalter”, a “micromalter” a “Montana Micro-Malter” or other grammatically equivalent expressions. In other exemplary embodiments, an “apparatus for germinating and malting grain” has a capacity of between 150 pounds and 600 lbs per week and is referred to herein as a “Montana MiniMalter”, a “minimalter” a “Montana Mini-Malter” or other grammatically equivalent expressions. In still other exemplary embodiments, an “apparatus for germinating and malting grain” has a capacity of between 500 pounds and 2000 lbs. per week and is referred to herein as a “Montana Malter”, a “malter” or other grammatically equivalent expressions.

The expression “germinated grains” as used herein, refers to seeds that have been germinated so as to maximize their potential to produce sugars and amino acids during post-malting processing.

The expression “water-saturated air” or “hydrated air” as used herein, refers to the infusion of small (less than 1 mm diameter) bubbles that have been moved through a column of water prior to moving through a bed of germinating grain. The degree of saturation (or hydration) is measured using an hygrometer.

The expression “germinating until germination is complete” as used herein, has its traditional meaning see e.g., Malts and Malting, Dennis E. Briggs (1998) Springer. In general, acrospire length (near end of seed) and rootlet length are proxy measurements that correlate reasonably well with endosperm modification. Thus in an exemplary embodiment, the expression “germinating until germination is complete” refers to germinating grain until seedling roots are approximately 1.5 cm in length and the acrospires is approximately ¾ the length of the grain. Typically, good malting barley germinates uniformly and completely in 3-4 days. However, as is appreciated by persons of ordinary skill in the art, other grains can take substantially longer, and small seeded grains can achieve complete modification more quickly.

The expression “kilning until kilning is complete” as used herein, refers to passing heated air through germinated grain until water content of the germinated grain is 10% or less. Thus, “kilning is complete” when water content of a germinated grain is 10% or less. In some exemplary embodiments, “kilning is complete” when water content of a germinated grain is 10%. In other exemplary embodiments, “kilning is complete” when water content of a germinated grain is 9%, 8%, 7%, 6%, 5%, 4% 3% or less percent.

### I. Introduction:

Craft breweries, distilleries and artisanal bakeries use germinated and dried grains to produce their beverages and foods. Since most germinated and dried grains are produced by large malthouses that produce thousands of tons of malt per year, only a limited number of large batch germinated and dried grains are typically available.

Craft brewers, distilleries and artisanal bakers are always in search of new and different flavors and textures. Since, the flavors and textures of the products of breweries and bakeries are strongly influenced by the type of germinated and dried grains used to produce them craft breweries, distilleries and artisanal bakeries benefit from having a wider selection of germinated and dried grains.

Accordingly, as discussed above, there is a need for a flexible, easy-to-use malting and grain germination system that permits users to produce small batches of unique malts and germinated grains to meet the desires craft brewers, distilleries and artisanal bakers.

Therefore, disclosed herein below is an apparatus and methods for malting and grain germination that enable users of malt and germinated grain to better-differentiate their products through use of unique malted and germinated grain.

### II. Apparatus for Germinating and Malting Grain

In an exemplary embodiment, the disclosure provides an apparatus for germinating and malting grain. The apparatus comprises a four-tank (or equivalently four-chamber) malting and seed germination system in which each tank (or chamber) performs steeping, germination and kilning. The apparatus permits a user to resteep the grain during germination if desired. Thus, the apparatus permits the user to maintain optimal seed moisture for optimal malts.

In addition to the tanks, the “apparatus for germinating and malting grain” comprises tank/chamber carts and a 2-track rail which facilitates the movement of the tanks/chambers from station to station. Typically, a tank/chamber cart is placed onto the 2-track rail and a tank for steeping, germination and kilning is placed upon the chamber cart. The chamber cart with the tank thereon is now easily moved from steeping station to the first germination station, the second germination station and finally to the kilning station.

As discussed briefly above, the “apparatus for germinating and malting grain” e.g., an “apparatus for germinating and malting grain” which is the size and capacity of a Montana Mini Malter, comprises rails to support the tank carts and tanks, plumbing to allow steeping and draining at the steep station and resteeping at each of the two germination stations.

In an exemplary embodiment, the apparatus for germinating and malting grain is the size and capacity of a Montana Mini Malter. In this embodiment, each tank (6) has a 4″ diameter offset hole (7) in its bottom. A camlock assembly is attached at the offset hole. The camlock assembly comprises a male fitting (8) is butt-welded to the offset hole (7). The complementary female camlock fitting (9) is attached to the male fitting (8) at a first end and is attached to the 1″ diameter ‘T’ fitting (10) at a second end. The valves (11) and (13) 1″ diameter tubing (12) and (14) permit water ingress and egress.

In an exemplary Mini Malter embodiment, the tanks are cylinders made of 14 gauge stainless steel. In this embodiment, the internal diameter of each tank is 26″, and the tanks are 36″ tall. Each tank has a 1″ wide rim at the top of the tank that is used to anchor the tank top, making a maximum outside diameter of 28″.

Tank Handles. Each tank has 8 handles welded to the tanks' exterior to facilitate tank removal from the cart. The handles are positioned 6″ and 24″ above the base of the tank in four rows of 2 handles each. Each row is positioned 90° from each other row.

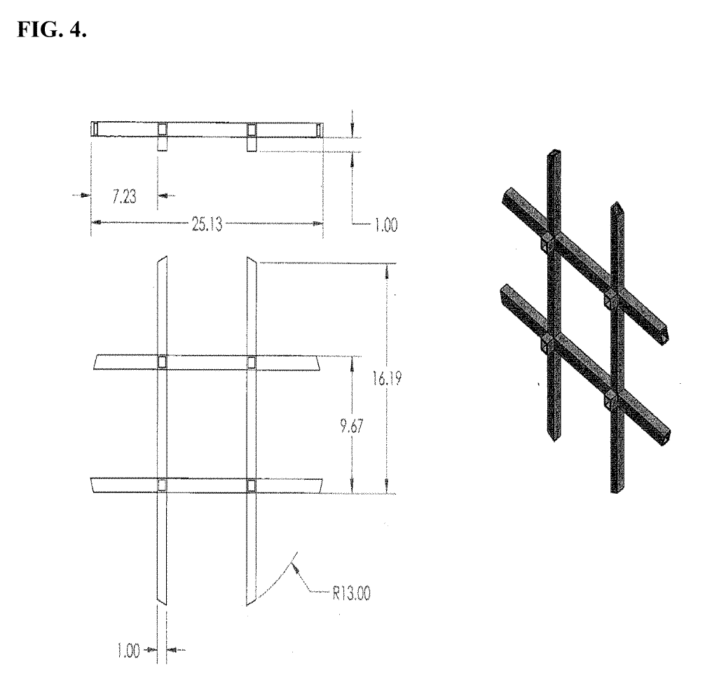

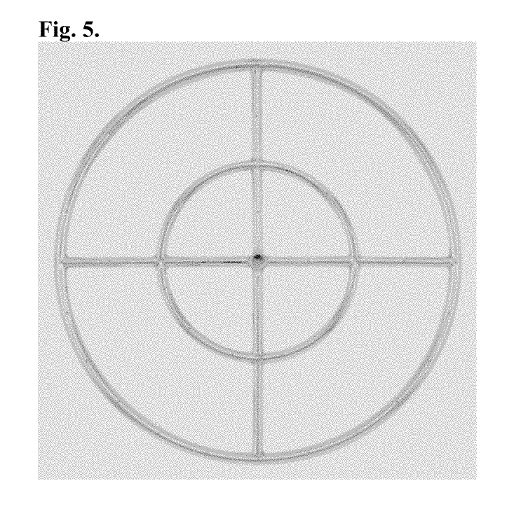

In an exemplary Mini Malter embodiment, each tank has a 1 inch plenum support structure (15) and FIG. 4, that rests on perforated stainless steel aeration ring (16) and FIG. 5 placed on the interior bottom of the tank, thereby creating a plenum that permits hydrated air distribution throughout the grain bed during steeping and germination. Atop the support structure (15) rests an air and water permeable screen (17) composed of perforated stainless steel or V-wire.

Perforated Stainless Steel Aeration Ring (16). In an exemplary embodiment, the aeration ring has an outside diameter of 24″ and provides excellent aeration during steeping and germination. In an exemplary embodiment, the aeration ring is commercially available. At the center of the Aeration Ring is a threaded orifice that accommodates a standard 1″ diameter barbed tubing fitting. Tygon® tubing (18) is fitted to the barb prior to introduction of the grain at the start of steeping. This tubing is then fitted to an air pump. During the two germination stages, the aeration ring is immersed in water, producing hydrated air.

Atop the plenum support (15) and aeration ring (16) is placed a 26″ diameter perforated stainless steel grain support (17). Holes in the support are selected to be slightly smaller than the diameter of the smallest seeds in the grain to be malted. This principle applies regardless of the size of the apparatus for germinating and malting grain e.g., for Micro Malter, Mini Malter and Malter. In an exemplary embodiment, the grain is 2-rowed malting barley and the holes in the grain support are 0.1 inch.

In an exemplary Mini Malter embodiment, the 2-track system is constructed from 2″ angle carbon steel and C-channel carbon steel or 14 gauge stainless steel. Each segment is 60″ long, with rail legs (16) 23″ long. The track X-braces (17) are 67.4″ in length and the track horizontal/cross braces (18) are 32.5″ long. The cross braces and X-braces may be attached to the rail legs at any point that provides stability to the overall track structure with the limitation that the cross braces and X-braces are attached so as to permit movement of the tanks from station to station without interference to the movement of the camlock assembly on the bottom of the tanks. Typically, a complete track system comprises three segments.

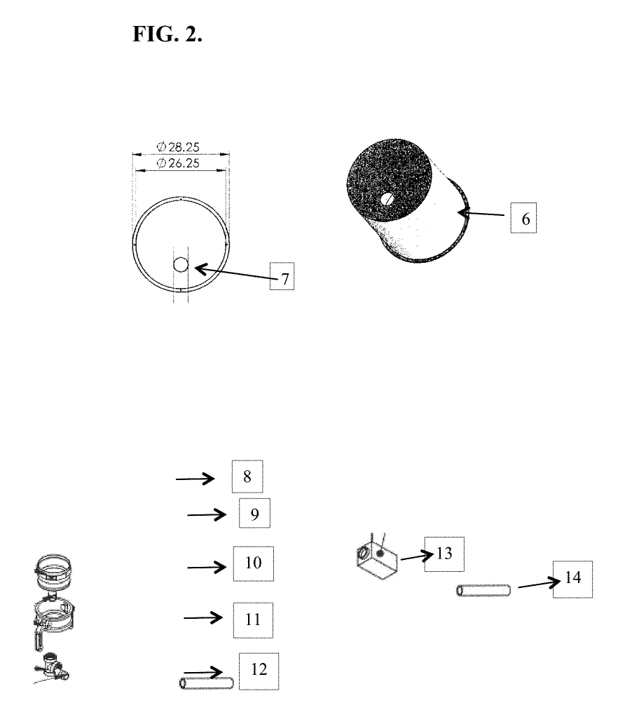

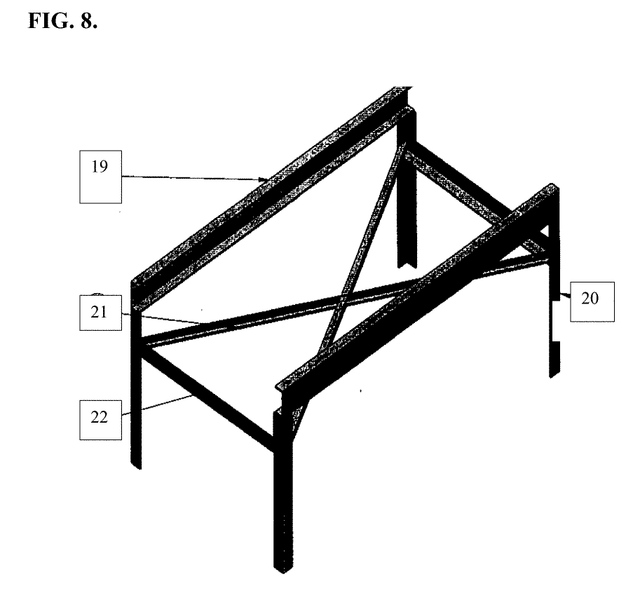

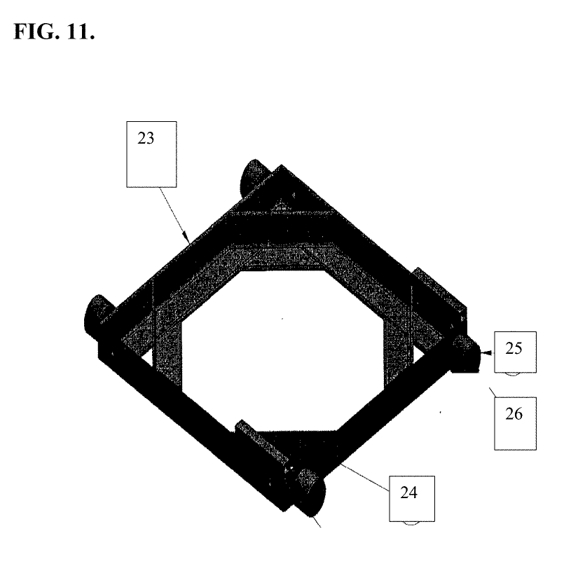

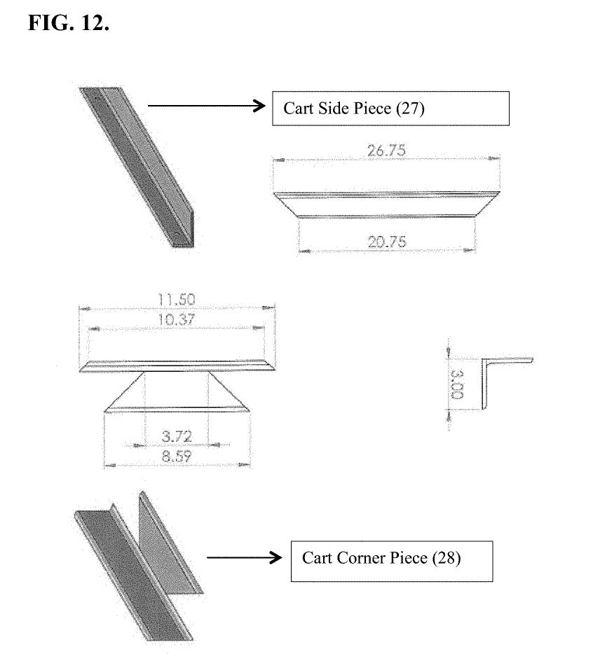

The tank/chamber cart carries the tanks (see FIG. 2) along the 2-track rail (FIG. 8) from station to station along the rail. The dimensions of the chamber carts are chosen so as to fit the tank cart on the 2-track rail system and so as to accommodate the tanks/chambers. Dimensions of a tank cart for use in an exemplary Mini-Malter embodiment are shown in FIG. 11 and FIG. 12 respectively.

In an exemplary embodiment, a 1″ diameter water supply line utilizes PEX (or equivalent) tubing. The water supply tubing is fitted to two powered solenoid valves (11 and 13). The ingress valve (13) is a ‘normally open’ valve that is closed when signaled by the water float sensor suspended in the interior of the tank at the steeping position. As water rises in the tank, this sensor signals the valve to close to prevent tank overflow (see commercially-available parts list in Example 4). The egress valve (11) is a ‘normally closed’ valve that is opened by an electronic timer (see commercially available parts list for examples). This valve is connected to a compatible 1″ diameter ‘T’(10) by 1″ diameter water supply line tubing. This ‘T’ fitting is attached to the female 4″ camlock cap (9) through a 1″ hole drilled in the camlock cap.

The opposite orifice of the camlock cap ‘T’ fitting is fitted with a 1″ diameter ‘T’ fitting that is used for tank drainage. Drainage tubing need not be high pressure tolerant, and in this example we utilize clear 1″ diameter Tygon® tubing for drainage. This ‘T’ is fitted to a ‘normally closed’ powered solenoid valve that is opened by an electronic timer to initiate tank drainage. The opposite orifice of this ‘T’ fitting is attached by drainage tubing to a manually controlled valve. This manual valve is attached to drainage tubing that connects to female camlock caps fitted with ‘T’ fittings as described above, and fitted with manually-controlled 1″ valves. At germination position 2, the water supply and drainage lines are connected to the camlock ‘T’ by elbows. The germination 1 and 2 position water supply and drainage lines provide an easy method for maintaining an optimal water level in the tank plenum, provide for easy resteeping, and promote effective tank drainage.

Grain temperature during germination is controlled by evaporative cooling and variable air pump speed. Increasing the rate of airflow through the grain results in increased evaporative cooling and decreased grain bed temperature. Resteeping may be performed at each of the germination stations by adding sufficient water through the water supply line to immerse the grain.

In exemplary embodiments, partial stewing of the germinating grain is performed at the second germination station by reducing fan speed and allowing the grain temperature to increase to 30-40° C.

When germination is complete e.g., when seedling roots are approximately 1.5 cm in length and the acrospire is ¾ the length of the grain, stewing may be accomplished by recycling heated, hydrated air through the grain until the grain temperature achieves 145° F. The grain is held at 145° F. for up to two hours. This permits the grain amylases and proteases to degrade starch and proteins, producing sugars and amino acids. When kilned, these react and produce the products of Maillard reactions.

Kilning is performed by passing electrically-warmed air through the grain bed using electric heaters and fans through the lower male fitting. Water is evaporated from the grain, resulting in a movement of a moisture front through the grain bed. Once water is removed from the grain, the temperature may be raised to produce malts of increased color and flavor.

Thus, the apparatus for germinating and malting grains disclosed herein provides a platform that can produce a wide variety of malts, including crystal (stewed and kilned) malts as well as malts of varied color and flavor. Furthermore, the platform permits the user to produce different and unique malts over a short duration of time. Typically, different malt can be harvested every two days.

### III. Production of Malt

A. General

Methods disclosed herein utilize routine techniques in the field of malting. Basic texts disclosing the general methods of use in this invention include, e.g., Malts and Malting Dennis E. Briggs (1998), Springer; and The Craft Maltsters Handbook Dave Thomas (2014) White Mule Press.

B. Grains

In an exemplary embodiment, the process disclosed herein utilizes barley as a grain for malting and/or germination. Any barley variety e.g., hulled or hulless (see e.g., Cereal Chemistry 76: 589-599) can be used.

Other grains suitable for malting and/or germinating as disclosed herein include, but are not limited to oats, wheat, corn, triticale, milo (grain sorghum), rye, millet, chickpeas, lentils and buckwheat.

C. Production of Malt Using the Apparatus for Germinating and Malting Grain

Malting grains must be harvested, stored and cleaned carefully to maintain their viability. Viable, non-dormant grain is required for the production of high quality, uniform malt or germinated grains.

In an exemplary embodiment, a tank having a camlock assembly (see FIG. 2) is placed on a tank cart (FIG. 11) at the steep position (1) of the 2-track rail system. The stainless steel aeration ring (16), with barbed fitting, is placed in the tank interior bottom, the tank plenum support (15) is placed atop the aeration ring (16). Tygon® tubing (18) (¾″ internal diameter) is fitted to the barbed portion of the aeration ring fitting, and the tubing is inserted through the 1″ diameter hole in the center of the stainless steel grain support screen (17). The grain support screen (17) is then placed atop the tank plenum support (15). The tubing (18) is fitted to a Danner mfg. AP-60 Air Pump, and aeration is initiated, through the Tygon® tubing that exits the tank through its top, and connects to the AP-60 Air Pump that is stationed beside the rail system. Malting grains are added to the chamber located at the steeping station. Water is added to the steeping station through the 4″ diameter hole at the bottom of the tank/chamber (7) which is fitted with the camlock assembly via the valve controlling water ingress (13) (See FIG. 2) and the grain is rinsed. Rinse water is drained through the 4″ diameter hole on the bottom of the tank/chamber (7) comprising the camlock assembly through the valve controlling water egress (11), completing the rinse cycle.

Fresh water is added through the water ingress valve (13), submerging the grain. The Aerating pump (for example a Dannon Mfg. AP-60 air pump) then forces air through the stainless steel aeration ring (16) placed on the bottom of the steep tank prior to addition of dry grain. Steeping with aeration is performed for eight hours following which time the water is drained through the water egress valve (11) and the grain is allowed a four hour air rest. This cycle of steeping and air rest is repeated until the grain has absorbed the desired amount of water, at which time the grain contains approximately 47% water by weight. Small-seeded grains typically reach optimal water content more rapidly than do large-seeded grains.

Following steeping, the chamber/tank (6) and FIG. 2, is rolled to the first germination station (2) at which water-saturated air is forced through the grain. The plenum at the bottom of the germination tank is filled with water, and air forced through the water using the aeration ring and aeration pump mentioned previously. A second tank may then be placed at the steeping station (1) where steeping of a second batch of grain may be initiated.

In an exemplary embodiment, the steeping, germination and kiln stations grain temperature is monitored using a 4-probe Maverick® Et-735 Bluetooth compatible oven thermometer. The Redi-Chek® application makes monitoring and collecting data from each tank/chamber straightforward. Air flow is controlled using an Active Air® fan controller. Air flow is adjusted to remove carbon dioxide that is produced by respiration during seed germination, and to maintain grain temperature at approximately 65° F.

The tank plenum void volume is approximately 5.5 gallons. Since grain cooling depends on evaporation of water from the hydrated air entering the grain bed, the water level in the germination 1 and germination chamber 2 plenums should be monitored to ensure that hydrated, rather than ambient air is entering the grain bed. This is easily done with a hygrometer. The maximum airflow supplied by the Danner mfg. AP-60 Air Pump is 5500 cubic inches per minute. In our experience, maintaining steep temperature at an optimal 53° F. requires approximately 60% of maximum airflow, while maintaining an optimal germination temperature of 65° F. requires approximately 40% of maximum airflow. This varies with seedling vigor and ambient air and water temperatures.

Resteeping may be performed at the first germination station if desired, and germinating grain may be stirred to reduce seedling root entanglement. In most malting systems, steeping is only possible in the steep tank, and resteeping during germination is not possible. Maintenance of optimal seed moisture percentage is critical for obtaining optimal malt. Resteeping during germination provides the user the ability to rapidly increase seed moisture content over a course of a few minutes. This is a feature of the Montana Malters family of malting and seed germination systems.

At the mid-point of germination, the chamber/tank is rolled to the second germination station (3), permitting the chamber/tank in the steep station (1) to be moved to the first germination station (2) and a new tank to be placed in the steep station (1). The relative ease with which tanks/chambers can be moved on their carts is a feature on the Montana MiniMalter family of malting systems. Moving tanks/chambers from station to station means that the steeped or germinating seeds are not moved mechanically or pneumatically until the end of kilning. This reduces damage to the developing malt and represents another feature of the Montana Malter family of malting systems.

This 4-tank system permits the kiln, the most expensive component of the malting system, to be used on alternate days. Using a typical 1-tank system, kiln use is often reduced to once per week. In contrast the apparatus for germinating and malting grain disclosed herein permits maltsters to vary the malt produced batch-by-batch, producing a different malt every two days.

When steeping is completed for the second batch of grain, the second tank/chamber is rolled to the first germination position (2). At this time a third tank may be positioned at the steeping station (1), grain added and steeping initiated as described above.

At the second germination station (3) grain temperature is monitored, and adjusted by adjustment of air flow as previously described. Resteeping may be performed at the second germination station if desired, and germinating grain may be stirred to reduce seedling root entanglement. In an exemplary embodiment, a stainless steel pitchfork is used to stir the grain during the third and fourth days of germination. When germination is complete, the chamber is rolled to the kiln station (4), and the other two chambers advanced to the second and first germination stations. At this time, a fourth chamber may be placed at the steeping station where steeping of a fourth batch of grain may be initiated.

At the kiln station (4), electrically-heated air is driven by fan through the grain bed by way of insulated 4″ ducting through the 4″ fitting on the bottom of the tank (7). The flexible ducting is attached to the barbed portion of a 4″ female barbed camlock fitting (9) (see parts list Example 4), and this is attached to the 4″ male fitting (8) welded to the base of the tank (camlock assembly). Grain drying is initiated, and continues until the moisture content of the grain at the top of the grain bed declines to less than 10%. At this point, the air temperature may be raised to produce malt or germinated grain of darker color.

Following kilning, the malted or dried germinated grain is pneumatically removed from the chamber and the malt or dried germinated grain is cleaned and packaged. Each of the three chambers remaining in the system is advanced to the next station, the first chamber cleaned and moved to the steeping position where a fifth batch of grain may be steeped. This cycle may be repeated.

### IV. Scalability

Those who are engaged in malting, brewing, distilling or artisanal baking will appreciate that the apparatus and methods disclosed herein provides the end-user with enhanced flexibility in the creation of artisanal malts and germinated grains of any desired quantity. Thus, Montana Malter permits maximum flexibility in raw material preparation for bakers, brewers and distillers. In an exemplary embodiment, in order to double batch size, e.g., for a size within Malter range, tank diameter is increased from 26″ to 37″, with corresponding increases in air pump, kiln fan and kiln heater capacity. To reduce batch size to 20 lbs, e.g., a size within mini-malter range, tank diameter is reduced to 9″ with corresponding reductions in air pump, fan and kiln heater capacity. For the specific application of experimentally evaluating a larger number of grain varieties, a tank/chamber may be fitted with vertical panels that divide the chamber into quarters or eighths.

The following examples are offered to illustrate, but not to limit the invention.

### EXAMPLES

### Example 1

The following example illustrates production of pale malt using the barley variety Hockett.

### Methodology

One hundred fifty pounds of Hockett barley were added to the first chamber of the Montana Mini-Malter. Approximately 25 gallons of water was added to submerge the grain 6″. Steeping was initiated and air infused through the aeration ring on the bottom of the chamber as previously described. Steeping was allowed to proceed for two days at approximately 53° F. until the moisture content of the grain was 48% water. After steeping for two days, the first chamber, containing the steeped grain was manually rolled to the first germination position. A Bluetooth compatible hygrometer probe is manually inserted into the steeped grain bed, taking care to place the probe on the stainless steel perforated grain support screen located above the tank plenum. The aeration ring was attached to a second Dannon AP-60 air pump through its Tygon® tubing, water added through the 4″ bottom fitting to submerge the aeration ring, and aeration and evaporative cooling initiated. Germination at the first germination station was allowed to proceed for 2.5 days.

After germinating for 2.5 days at the first germination station, the first chamber was moved to the second germination position and germination was continued using water-saturated air as previously described. Manual stirring of the grain was performed using a stainless steel pitch fork at the end of 3 days and midway through the fourth day of germination.

When germination at the second germination station was completed, the first chamber was moved to the kiln position. At the kilning position, air was forced through the grain bed via the 4″ fitting at the tank bottom using insulated 4″ ducting, with entry air temperature approximately 160° F. The moisture front moved through the grain bed, reaching the top of the grain bed in approximately 16 hours. At this point, the kiln heater temperature was increased to finish the malt at 185° F. for two hours. We produced a pale malt that produce wort of 3° Lovibond.

Malt was then allowed to cool, and is removed from the kiln tank/chamber using a ShopVac vacuum system. This has the dual advantages of removing the malt from the chamber gently and also rubbing the roots and coleoptiles from the finished malt.

### Results

Following pneumatic malt removal and cleaning, malt was produced with the following characteristics: 84% friable, 80% extract, 3° Lovibond.

### Conclusion

Using Hockett barley, the Montana Malter produces pale malt similar to two-rowed pale barley malt produced by large malt producers in the US.

### Example 2

The following Example illustrates the use of the Montana Malter for the production of partially stewed Hockett barley malt.

### Methodology

Hockett barley grain was steeped as described above in Example 1. The chamber containing the steeped grain was moved to the first germination position once grain water content reached 48% (2 days). Germination proceeded with aeration using water saturated air for 2.5 days, after which time the chamber was moved to the second germination position. At the second germination chamber, airflow was restricted and grain temperature was permitted to rise to 110° F. using heat generated by grain respiration. After four hours at 110° F., grain was cooled by evaporative cooling to 60° F. Germination continued until rootlets were approximately 1.5cm long. The chamber containing the germinated grain was then moved to the kiln position and kilning initiated. Kilning was carried out for 16 hours using the air heater system previously described. The Bluetooth compatible 4-position thermometer (see parts list) provided continuous monitoring of grain temperature at 4 elevations in the grain bed, and it was simple to observe the dramatic temperature rise in the grain by position as grain moisture declined. Initial kilning was complete when the top of the grain bed reached 140° F. Following kilning, malt was pneumatically removed from the chamber and cleaned.

### Results

The malt produced using this method tasted sweet, and noticable Maillard reaction products were produced as determined by flavor.

### Conclusion

Using respiration-based heating of seed resulted in increased starch availability for hydrolysis by grain amylases, and increased grain protein availability to proteinase activity. This resulted in free amino nitrogen and reducing sugar availability that resulted in increased maillard reaction products during kilning.

### Example 3

The following Example illustrates use of the Montana Mini-Malter for the production of pale malt from hulless oat (Avena sativa).

### Methodology

One hundred pounds of hulless oat were added to the first chamber. Steeping was initiated, and proceeded, with standard air rests, for two days at approximately 57° F. until the grain achieved a water content of 49%. After steeping, the chamber was moved to the first germination position and aeration continued as previously described and germination was initiated. Germination at the first germination station was carried out for two days. After the first germination period the chamber was moved to the second germination position and germination continued using hydrated air. During germination at the second germination station (at days 3 and 4), stirring was done twice. When germination at the second germination station was complete as determined by rootlet and coleoptile length as known in the art (see e.g., Malts and Malting (1998) supra) the chamber was moved to the kiln position. Air was forced through the grain bed, with entry air temperature approximately 240° F. The moisture front moved through the grain bed, reaching the top of the grain bed in approximately 16 hours.

### Result

Pale oat malt was produced that was then used to produce a very tasty granola.

### Conclusion

The Montana Malter produces hulless oat malt, a novel specialty grain malt, with the attributes that contribute to the production of a superior whole grain breakfast food.

### Example 4

The following Example illustrates commercially available parts useful for constructing an apparatus for germinating and malting grain as disclosed herein

### Tank/Chamber Assembly:

| | | | Quantity |
|---|---|---|---|
| Item | Source | Catalog No. | Required |
| 4″ male camlock with | McMaster-Carr | 53015K343 | 4 |
| butt weld connection | | | |
| 4″ female capped camlock | McMaster-Carr | 51415K88 | 3 |
| 1″ Tee pipe fitting | McMaster-Carr | 4470SK348 | 3 |
| 1″ Brass Barbed Hose Fitting | McMaster-Carr | 5346K71 | 6 |
| Steep Overflow Sensor | Omega.com | LV-70 | 1 |
| Steep Overflow control valve | Omega.com | SV6005 | 1 |
| Aeration Pump | Danner mfg. | AP-60 | 3 |

### Air Heating System

| | | | Quantity |
|---|---|---|---|
| Item | Source | Catalog No. | Required |
| Watlow 12 KW Heater | E&M Sales | MDH12S10WK | 1 |
| Watlow DIN-a mite | E&M Sales | DD10-24C0-0000 | 2 |
| controller | | | |
| Watlow EZ-Zone | E&M Sales | PM8C2CJ2LEJAAA | 1 |
| controller | | | |
| Tjernlund 10″ | sustain- | w262557 | 1 |
| in-line fan | ablesupply | | |
| Fan Speed Controller | Active Air | 3810400523 | 4 |

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An apparatus for germinating and malting grain, the apparatus comprising:
(i) four tanks suitable for steeping, germinating and kilning grain, wherein each tank comprises a tank bottom and a tank top,
wherein the tank bottom has a closed side and an open side, and wherein a male fitting is attached to an opening in the closed side thereby providing a channel through which substances may enter and/or exit the tank through the tank bottom,
and wherein the tank top has a closed side and an open side, wherein a male fitting is attached to an opening in the closed side thereby providing a channel through which substances may enter and/or exit the tank through the tank top,
and wherein the tank top and the tank bottom are oriented such that the open side of the tank bottom is up and the open side of the tank top is down,
and wherein the tank bottom has an interior and an exterior and the tank bottom interior has a floor, wherein the floor has upon it and aeration ring, and wherein a support structure is placed on the tank bottom above the aeration ring and a screen is on top of the support structure;
(ii) four tank carts, wherein each tank cart comprises: a square frame having a top side and a bottom side, wherein the top side accommodates a tank, and wherein a wheel is affixed to each corner of the bottom side;
(iii) a 2-track rail which comprises segments, each segment comprising: (a) a first C-channel rail and a second C-channel rail wherein each C-channel rail has a top side and a bottom side and has a left end and a right end and wherein the first C-channel rail and the second C-channel rail are oriented horizontally with respect to the ground and parallel to each other wherein the top sides of the C-channel rails are oriented up and the bottom sides are oriented down; (b) four rail legs wherein each rail leg has a top end and a bottom end, wherein a first rail leg is attached at the top end to the bottom side of the left end of the first C-channel rail, a second rail leg is attached at the top end to the bottom side of the right end of the first C-channel rail, a third rail leg is attached at the top end to the bottom side of the right end of the second C-channel rail, and a fourth rail leg is attached at the top end to the bottom side of the right end of the second C-channel rail (c) a first cross brace and a second cross brace wherein each cross brace has a first end and a second end, wherein the first cross brace is attached by the first end to the first rail leg and is attached by the second end to the third rail leg, and wherein the second cross brace is attached by the first end to the second rail leg and is attached by the second end to the fourth rail leg; (d) a first X-brace and a second X-brace wherein each X-brace has a first end and a second end, wherein the first X-brace is attached by the first end to the first rail leg and the first end of the first cross brace and is attached by the second end to the fourth rail leg and the second end of the second cross brace, and wherein the second X-brace is attached by the first end to the second rail leg and the first end of the second cross brace and is attached by the second end to the third rail leg and the second end of the first cross brace,
wherein the 2-track rail provides a path along which is a steeping station, a first germination station, a second germination station, and a kilning station;
wherein the steeping station comprises plumbing to provide a water supply line, a water drain line and an air supply line,
wherein the first germination station comprises plumbing to provide an air supply line a water supply line and a water drain line,
wherein the second germination station is comprises plumbing to provide an air supply line a water supply line and a water drain line,
wherein the kilning station is comprises a kiln plenum with a heating element and an in-line fan capable of providing 600 cubic feet of air per minute.

2. The apparatus of claim 1, wherein the apparatus comprises three segments of 2-track rail.

3. The apparatus of claim 1, wherein the tanks are 36 inches high, have an internal diameter of 26 inches and external diameter of 28 inches and wherein the tanks are made of 14 gauge stainless steel.

4. The apparatus of claim 3, wherein the apparatus is used to produce 0.3 tons of malt per week.

5. The apparatus of claim 2, wherein each C-channel rail is 60 inches long, each rail leg is 23 inches long, each cross brace is 32.5 inches long and each X-brace is 67.4 inches long.

6. The apparatus of claim 1, wherein the tanks are 36 inches high, have an internal diameter of 9 inches.

7. The apparatus of claim 6, wherein the apparatus is used to produce 20 pounds of malt per week.

8. The apparatus of claim 1, wherein the tanks are 36 inches high, have an internal diameter of 37 inches.

9. The apparatus of claim 8, wherein the apparatus is used to produce one ton of malt per week.

10. A method for steeping, germinating, drying and curing grain using an apparatus for germinating and malting grain, the method comprising:
(i) placing a first tank cart on the 2-track rail at the steeping station,
(ii) placing a first tank suitable for steeping, germinating and kilning grain on the first tank cart,
(iii) adding grain to a first tank suitable for steeping, germinating and kilning grain
(iv) steeping the grain in the first tank suitable for steeping, germinating and kilning grain until steeping is complete;
(v) moving the first tank cart along the 2-track rail to the first germination station;
(vi) allowing the grain in the first tank suitable for steeping, germinating and kilning grain to germinate until germination is half complete;
(vii) placing a second tank cart on the 2-track rail at the steeping station;
(viii) placing the second tank suitable for steeping, germinating and kilning grain on the second tank cart,
(ix) adding grain to a second tank suitable for steeping, germinating and kilning grain
(x) steeping the grain in the second tank suitable for steeping, germinating and kilning grain until steeping is complete;
(xi) moving the first tank cart along the 2-track rail to the second germination station and moving the second tank cart along the 2-track rail to the first germination station;
(xii) allowing the grain in the first tank suitable for steeping, germinating and kilning grain to germinate until germination is complete and allowing the grain in the second tank suitable for steeping, germinating and kilning grain to germinate until germination is half complete;
(xiii) placing a third tank cart on the 2-track rail at the steeping station;
(xiv) placing the third tank suitable for steeping, germinating and kilning grain on the third tank cart,
(xv) adding grain to a third tank suitable for steeping, germinating and kilning grain;
(xvi) steeping the grain in the third tank suitable for steeping, germinating and kilning grain until steeping is complete;
(xvii) moving the first tank cart along the 2-track rail to the kilning station, moving the second tank cart along the 2-track rail to the second germination station and moving the third tank cart along the 2-track rail to the first germination station;
(xviii) allowing the grain in the first tank suitable for steeping, germinating and kilning grain to kiln until kilning is complete, allowing the grain in the second tank suitable for steeping, germinating and kilning grain to germinate until germination is complete; allowing the grain in the third tank suitable for steeping, germinating and kilning grain to germinate until germination is half complete;
(xix) placing a fourth tank cart on the 2-track rail at the steeping station;
(xx) placing the fourth tank suitable for steeping, germinating and kilning grain on the fourth tank cart,
(xxi) adding grain to a fourth tank suitable for steeping, germinating and kilning grain;
(xxii) steeping the grain in the fourth tank suitable for steeping, germinating and kilning grain until steeping is complete;
(xxiii) removing the first tank suitable for steeping, germinating and kilning grain
from the kiln when kilning is complete, thereby
steeping, germinating, drying and curing grain using an apparatus for germinating
and malting grain.

11. The method of claim 10, wherein, prior to step vii adding water to the first tank suitable for steeping germinating and kilning grain and resteeping the grain therein.

12. The method of claim 10, wherein, prior to step xiii adding water to the second tank suitable for steeping germinating and kilning grain and resteeping the grain therein.

13. The method of claim 10, wherein, prior to step xix adding water to the first tank suitable for steeping germinating and kilning grain and resteeping the grain therein.

14. The method of claim 10, wherein the grain is barley (Hordeum vulgare), producing pale malt.

15. The method of claim 10, wherein said grain is barley (Hordeum vulgare), used to produce partially stewed malt.

16. The method of claim 10, wherein said grain is hulless oats (Avena sativum), producing pale oat malt.
